(19) United States
(12) Patent Application Publication
(10) Pub. No.: US 2006/0081725 A1
(43) Pub. Date: Apr. 20, 2006

(54) Airless spray gun

(76) Inventors: Steven P. Plager, Eden Prairie, MN (US); Eric J. Finstad, Rogers, MN (US); Steven R. Kuczenski, New Brighton, MN (US); Craig J. Wojciechowski, Zimmerman, MN (US); Harold D. Johnson, Buffalo, MN (US)

Correspondence Address: Douglas B. Farrow, Esquire;Corporate Intellectual Property Counsel, Graco Minnesota Inc., P.O. Box 1441, Minneapolis, MN, 55440-1441, US

(21) Appl. No.: 10/713,916

(22) Filed: Apr. 22, 2003

(51) Int. Cl. B05B 7/02

(52) U.S. Cl. 239/526; 239/583; 239/575

(57) ABSTRACT

An airless spray gun is provided with a trigger guard which may be detached from the gun body at its upper end and then used as a wrench to unscrew the handle from the gun body or housing. The filter is located in the handle and is designed so that fluid flows from the inside out. This construction provides for debris to be trapped inside the filter rather than inside the gun handle thereby providing easier removal of the filter from the handle. A simplified needle assembly is provided which requires no adjustment and which is easy to service and assemble.

### RELATED APPLICATIONS

This application claims the benefit of U.S. Application Ser. No. ______, filed ______.

### BACKGROUND OF THE INVENTION

Airless spray guns for the application of paint and similar materials are well known. One perennial problem with such guns is that they tend to become covered in dried paint after use making disassembly for cleaning and maintenance difficult. This difficulty is further compounded by the need for tools which may not be at hand.

### SUMMARY OF THE INVENTION

It is therefore an object of this invention to provide an airless gun which is easily disassembled and which minimizes the need for tools, particularly special tools, to do so.

Towards that end, the spray gun of the instant invention is provided with a trigger guard which may be detached from the gun body at its upper end and then used as a wrench to unscrew the handle from the gun body or housing. The filter is located in the handle and is designed so that fluid flows from the inside out in contrast to known guns which typically flow from the outside in. This construction provides for debris to be trapped inside the filter rather than inside the gun handle thereby providing easier removal of the filter from the handle. A simplified needle assembly is provided which requires no adjustment and which is easy to service and assemble.

These and other objects and advantages of the invention will appear more fully from the following description made in conjunction with the accompanying drawings wherein like reference characters refer to the same or similar parts throughout the several views.

### A BRIEF DESCRIPTION OF THE DRAWINGS

FIG. 1 is an exploded view of the instant invention.

FIG. 2 is a perspective view of the trigger guard/wrench of the instant invention.

FIG. 3 is a detailed view showing the engagement of the trigger guard with the gun body.

FIG. 4 is a detailed view showing the engagement of the trigger guard with the handle at the bottom of the gun.

FIG. 5 is a cross-sectional view of the spray gun.

FIG. 6 is a cross-sectional view of the spray gun detailing the needle assembly.

FIG. 7 is an exploded view of the needle assembly.

### DESCRIPTION OF THE PREFERRED EMBODIMENT

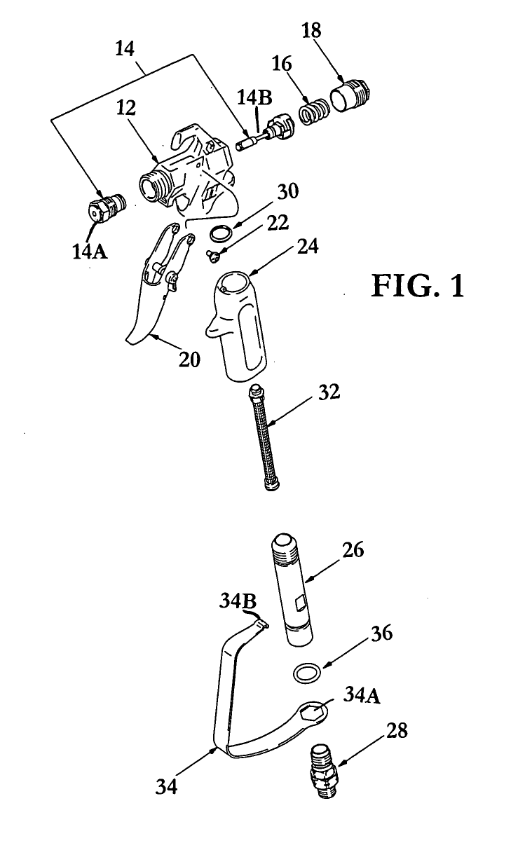

The instant invention, generally designated 10 in FIG. 1, is generally comprised of a gun body or housing 12 having therein a needle assembly 14 (described more fully hereinafter) and held in body 12 by spring 16 and nut 18. A trigger 20 is pivotably attached via screws 22. Handle 24 is keyed into body 12 at the top end thereof and is held in place by handle tube 26 which screws into body 12.

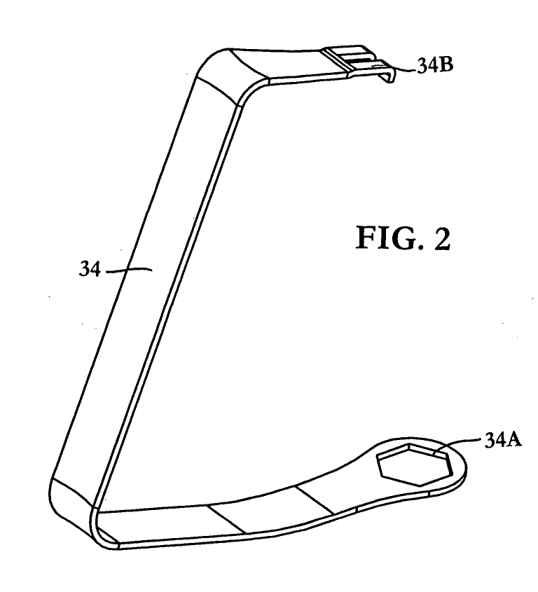

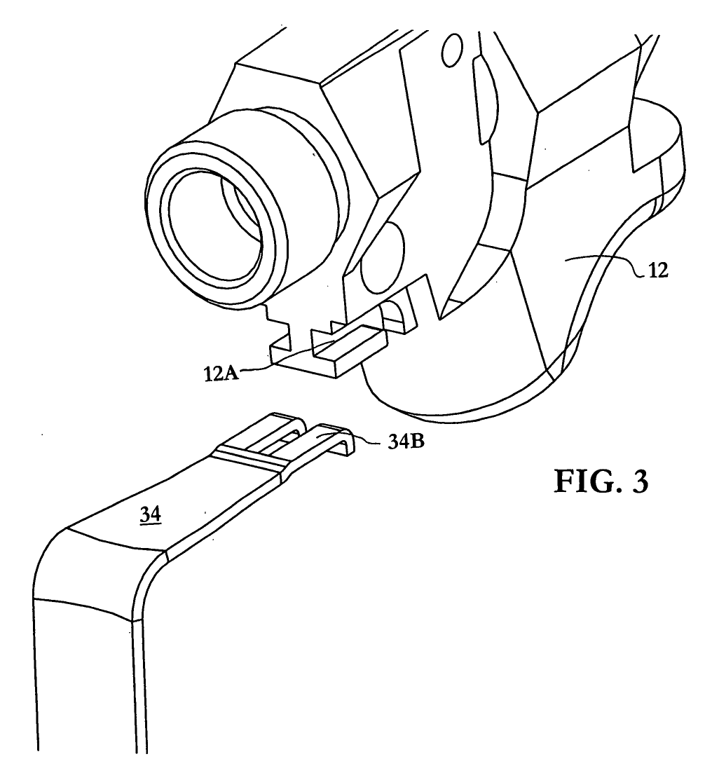

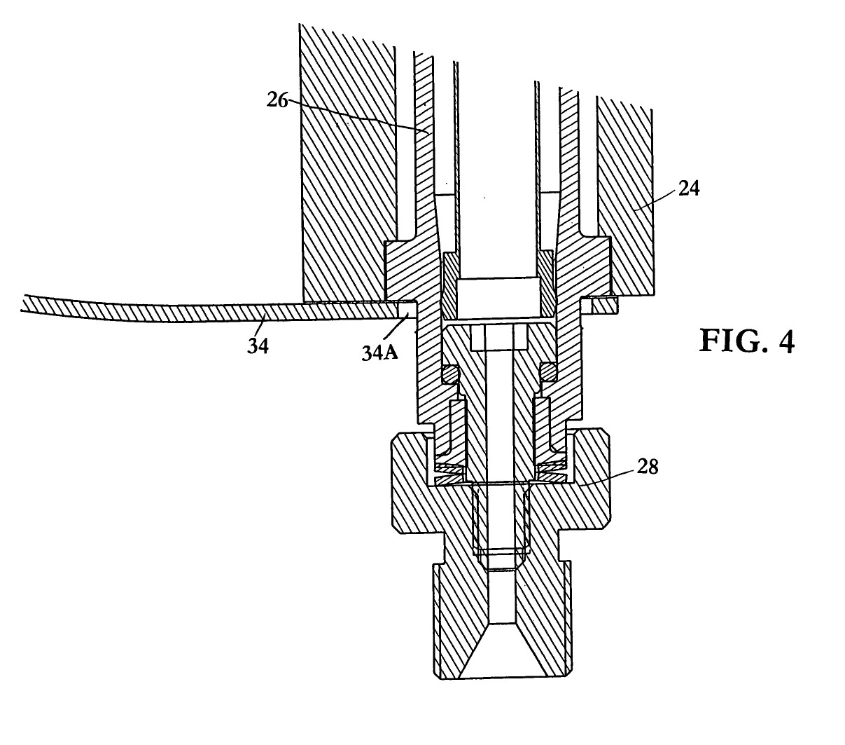

As shown in FIGS. 2-4, trigger guard/wrench 34 has a hex-shaped opening 34A which can engage swivel 28 to unscrew handle tube 26 and handle 24 from body 12. To do so, the operator unlatches the top end 34B by lifting slightly over latch 12A and pulling outward and then sliding the hex 34A over the swivel 28 and unscrewing.

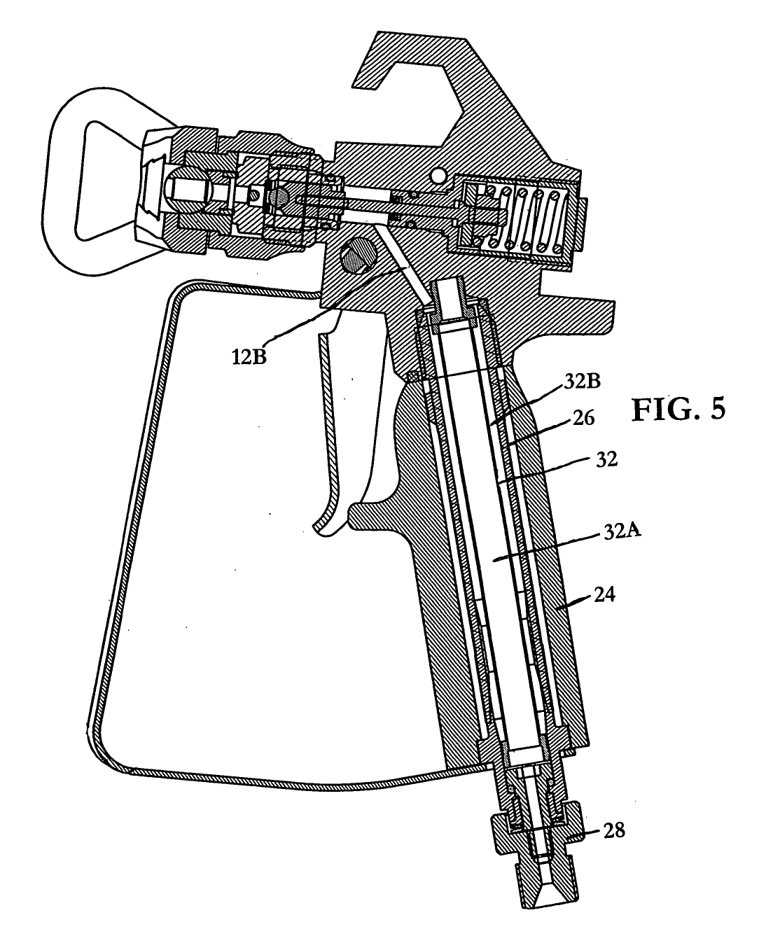

As can best be seen in FIG. 5, filter 32 is inserted into the handle tube 26 and has an interior cavity 32A where incoming paint flows. Such paint then passes through the filter itself (normally a screen type filter) and thence into outlet cavity 32B before flowing into outlet passage 12B.

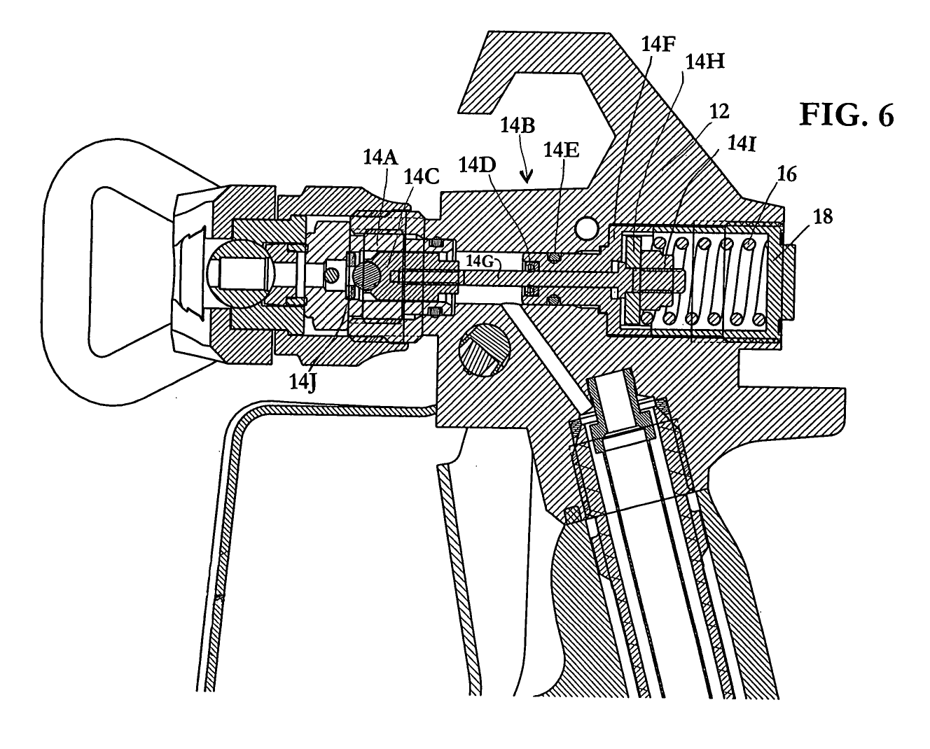

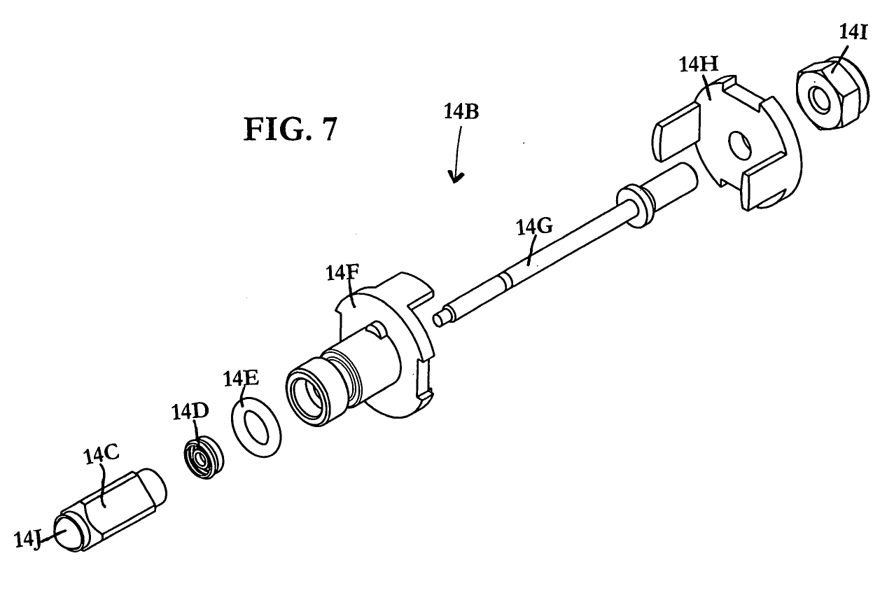

Needle assembly 14 is detailed in FIGS. 1, 6 and 7. In particular, seat/diffuser 14A is screwed into the front end of body 12. The rest of the assembly is installed already assembled as shown in FIG. 1. That portion of the assembly 14 is comprised of a needle end 14C having a ball 14J on the end thereof. A U-cup seal 14D and an O-ring seal 14E provide sealing on the end of seal housing 14F. Needle 14G is sandwiched between seal housing 14F and push plate 14H. Needle 14G is threaded at the front end to needle end 14C and at the rear to lock nut 14I.

It is contemplated that various changes and modifications may be made to the airless spray gun without departing from the spirit and scope of the invention as defined by the following claims.

What is claimed is:

1. An airless spray gun having a body, a handle tube screwed into said body and a trigger guard, the improvement comprising said trigger guard having first and second ends, said first end being selectively engagable with said gun body and said second end having an opening shaped to engage said handle tube so that said first end may be disengaged from said gun body and said second end used to unscrew said handle tube from said body.

2. An airless spray gun having a body, an inlet swivel, a handle tube screwed into said body and a filter, the improvement comprising an annular filter element having an interior cavity connected to said inlet swivel, said annular filter element being located in said handle tube an having an annular outlet cavity between said filter element and said handle tube, said outlet cavity being connected to said gun body for spraying.

3. A needle assembly for use in an airless spray gun, said needle assembly comprising:
a seat;
a needle end having a ball at the front end thereof for engaging said seat;
a seal housing having internal an external seals;
a push plate;
a needle having front and rear ends; and
a fastener, said needle end being secured to said needle front end and said needle rear end being sandwiched between said seal housing and said push plate, said fastener securing said needle rear end to said push plate.
